(19) United States
(12) Patent Application Publication
(10) Pub. No.: US 2025/0200957 A1
(43) Pub. Date: Jun. 19, 2025

(54) FORWARD AND BACKWARD EMBEDDING FUSION FOR VIDEO PANOPTIC SEGMENTATION

(71) Applicant: SAMSUNG ELECTRONICS CO., LTD., Suwon-si (KR)

(72) Inventors: Qingfeng LIU, San Diego, CA (US); Mostafa EL-KHAMY, San Diego, CA (US); Kee-Bong SONG, San Diego, CA (US)

(73) Assignee: SAMSUNG ELECTRONICS CO., LTD., Suwon-si (KR)

(21) Appl. No.: 18/933,593

(22) Filed: Oct. 31, 2024

Related U.S. Application Data
(60) Provisional application No. 63/656,777, filed on Jun. 6, 2024.
(60) Provisional application No. 63/610,544, filed on Dec. 15, 2023.

(51) Int. Cl. G06V 10/80; G06V 10/764; G06V 20/40

(52) U.S. Cl. CPC G06V 10/806; G06V 10/764; G06V 20/46; G06V 20/49

(57) ABSTRACT

A system and a method are disclosed for performing video segmentation, including obtaining a plurality of frames from an input video; extracting a plurality of features from the plurality of frames; obtaining query embeddings corresponding to the plurality of features; refining the query embeddings in a forward time order to generate forward embeddings, and in a backward time order to generate backward embeddings; fusing the forward embeddings and the backward embeddings to obtain fused embeddings; and generating a classification prediction corresponding to the input video based on the fused embeddings.

### CROSS-REFERENCE TO RELATED APPLICATION

This application claims the priority benefit under 35 U.S.C. § 119 (e) of U.S. Provisional Application No. 63/610,544, filed on Dec. 15, 2023, and U.S. Provisional Application No. 63/656,777, filed on Jun. 6, 2024, the disclosures of which are incorporated by reference in their entirety as if fully set forth herein.

### TECHNICAL FIELD

The disclosure generally relates to video panoptic segmentation. More particularly, the subject matter disclosed herein relates to improvements to video segmentation techniques by using forward and backward embedding fusion.

### SUMMARY

Video panoptic segmentation is a task that involves identifying, segmenting, and tracking the classes of all instances of objects of interest and background objects in a video simultaneously. Approaches for video panoptic segmentation include online approaches and offline approaches.

For example, some online approaches, which may be referred to for example as online video instance segmentation (VIS), follow a pipeline of segmenting and associating instances. These approaches may take a window of frames as input, and may track the instances within the window using the instance embeddings as the tracking feature.

As another example, some offline approaches may take the entire video or a large window size of frames as input, and may utilize the temporal information of the whole video to refine the output of the online approach, which can significantly improve the segmentation and tracking accuracy.

One issue with the above approaches is that they generally consider only the forward pass of a video as input, which may limit overall performance.

To overcome this issue, systems and methods described herein are directed to an approach which takes both a forward pass of the video and a backward pass of the video as input to further improve the performance of the offline approach and the online approach.

The above approaches improve on previous methods because they include a forward and backward embedding fusion (FBEF) module which utilizes both forward and backward temporal information based on the forward and backward embedding features to provide improved performance.

As a result, embodiments are directed to a video panoptic segmentation system that is able to achieve improved performance in comparison with other approaches, for example approaches using decoupled VIS (DVIS) offline models.

In an embodiment, a method comprises obtaining a plurality of frames from an input video; extracting a plurality of features from the plurality of frames; obtaining query embeddings corresponding to the plurality of features; refining the query embeddings in a forward time order to generate forward embeddings, and in a backward time order to generate backward embeddings; fusing the forward embeddings and the backward embeddings to obtain fused embeddings; and generating a classification prediction corresponding to the input video based on the fused embeddings.

In an embodiment, a system comprises an image encoder configured to extract a plurality of features from a plurality of frames included in an input video; a transformer decoder configured to obtain query embeddings corresponding to the plurality of features; an embedding module configured to refine the query embeddings in a forward time order to generate forward embeddings, and in a backward time order to generate backward embeddings; a fusion module configured to fuse the forward embeddings and the backward embeddings to obtain fused embeddings; and a classification module configured to generate a classification prediction corresponding to the input video based on the fused embeddings.

### BRIEF DESCRIPTION OF DRAWING

In the following section, the aspects of the subject matter disclosed herein will be described with reference to exemplary embodiments illustrated in the figures, in which:

FIG. 1 is a block diagram of an example system for performing image segmentation, according to embodiments.

FIG. 2 is a flow chart of an example process for performing image segmentation, according to embodiments.

FIG. 3 is a block diagram of an example embedding module, according to embodiments.

FIG. 4 is a flow chart of an example process for generating embeddings, according to embodiments.

FIG. 5 is a block diagram of an example embedding module, according to embodiments.

FIG. 6 is a flow chart of an example process for generating embeddings, according to embodiments.

FIG. 7 is a block diagram of an example forward and backward embedding fusion module, according to embodiments.

FIG. 8 is a block diagram of an example fusion learning block, according to embodiments.

FIG. 9 is a flow chart of an example process for generating fusion weights, according to embodiments.

FIG. 10 is a block diagram of an example system for performing image segmentation, according to embodiments.

FIG. 11 is a block diagram of an example system for performing image segmentation, according to embodiments.

FIGS. 12A and 12B are block diagrams of example image encoders, according to embodiments.

FIG. 12C is a block diagram of an example multi-receptive field feature pyramid, according to embodiments.

FIG. 13 is a flow chart of an example process for performing image segmentation, according to embodiments.

FIG. 14 is a block diagram of an electronic device in a network environment, according to an embodiment.

FIG. 15 shows a system including a UE and a gNB in communication with each other.

### DETAILED DESCRIPTION

In the following detailed description, numerous specific details are set forth in order to provide a thorough understanding of the disclosure. It will be understood, however, by those skilled in the art that the disclosed aspects may be practiced without these specific details. In other instances, well-known methods, procedures, components and circuits have not been described in detail to not obscure the subject matter disclosed herein.

Reference throughout this specification to “one embodiment” or “an embodiment” means that a particular feature, structure, or characteristic described in connection with the embodiment may be included in at least one embodiment disclosed herein. Thus, the appearances of the phrases “in one embodiment” or “in an embodiment” or “according to one embodiment” (or other phrases having similar import) in various places throughout this specification may not necessarily all be referring to the same embodiment. Furthermore, the particular features, structures or characteristics may be combined in any suitable manner in one or more embodiments. In this regard, as used herein, the word “exemplary” means “serving as an example, instance, or illustration.” Any embodiment described herein as “exemplary” is not to be construed as necessarily preferred or advantageous over other embodiments. Additionally, the particular features, structures, or characteristics may be combined in any suitable manner in one or more embodiments. Also, depending on the context of discussion herein, a singular term may include the corresponding plural forms and a plural term may include the corresponding singular form. Similarly, a hyphenated term (e.g., “two-dimensional,” “pre-determined,” “pixel-specific,” etc.) may be occasionally interchangeably used with a corresponding non-hyphenated version (e.g., “two dimensional,” “predetermined,” “pixel specific,” etc.), and a capitalized entry (e.g., “Counter Clock,” “Row Select,” “PIXOUT,” etc.) may be interchangeably used with a corresponding non-capitalized version (e.g., “counter clock,” “row select,” “pixout,” etc.). Such occasional interchangeable uses shall not be considered inconsistent with each other.

Also, depending on the context of discussion herein, a singular term may include the corresponding plural forms and a plural term may include the corresponding singular form. It is further noted that various figures (including component diagrams) shown and discussed herein are for illustrative purpose only, and are not drawn to scale. For example, the dimensions of some of the elements may be exaggerated relative to other elements for clarity. Further, if considered appropriate, reference numerals have been repeated among the figures to indicate corresponding and/or analogous elements.

The terminology used herein is for the purpose of describing some example embodiments only and is not intended to be limiting of the claimed subject matter. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being on, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

The terms “first,” “second,” etc., as used herein, are used as labels for nouns that they precede, and do not imply any type of ordering (e.g., spatial, temporal, logical, etc.) unless explicitly defined as such. Furthermore, the same reference numerals may be used across two or more figures to refer to parts, components, blocks, circuits, units, or modules having the same or similar functionality. Such usage is, however, for simplicity of illustration and ease of discussion only; it does not imply that the construction or architectural details of such components or units are the same across all embodiments or such commonly-referenced parts/modules are the only way to implement some of the example embodiments disclosed herein.

Unless otherwise defined, all terms (including technical and scientific terms) used herein have the same meaning as commonly understood by one of ordinary skill in the art to which this subject matter belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As used herein, the term “module” refers to any combination of software, firmware and/or hardware configured to provide the functionality described herein in connection with a module. For example, software may be embodied as a software package, code and/or instruction set or instructions, and the term “hardware,” as used in any implementation described herein, may include, for example, singly or in any combination, an assembly, hardwired circuitry, programmable circuitry, state machine circuitry, and/or firmware that stores instructions executed by programmable circuitry. The modules may, collectively or individually, be embodied as circuitry that forms part of a larger system, for example, but not limited to, an integrated circuit (IC), system on-a-chip (SoC), an assembly, and so forth.

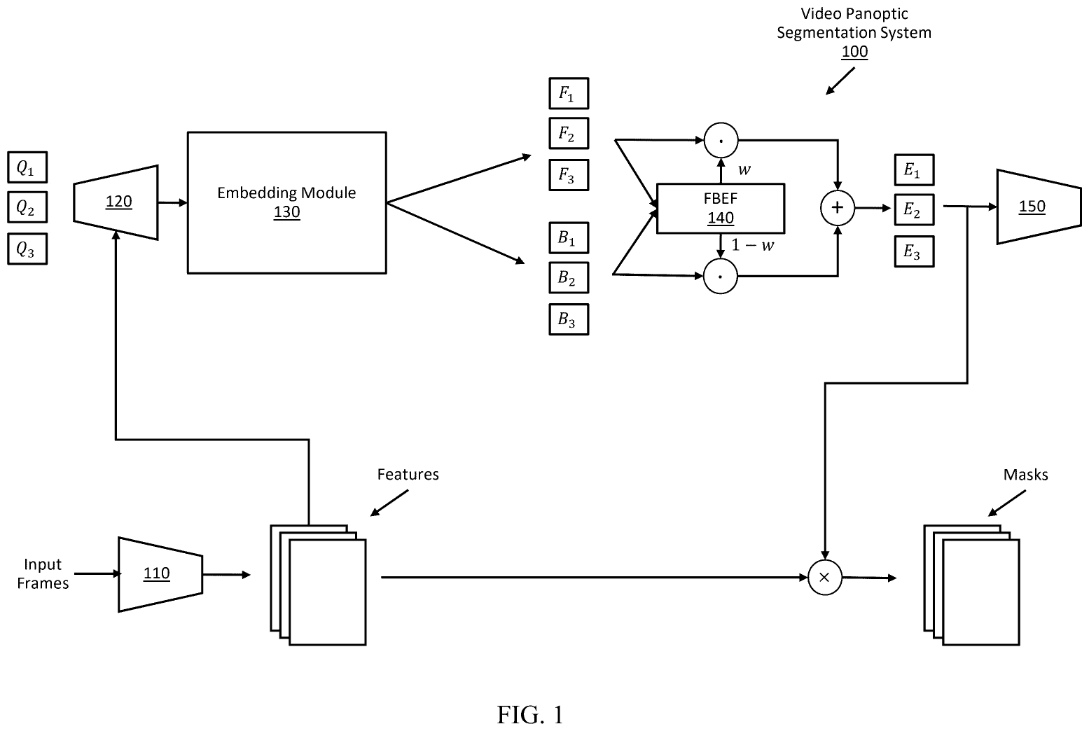

FIG. 1 is a block diagram of an example system 100 for performing image segmentation, according to embodiments. As shown in FIG. 1, the system 100 may include an image encoder 110, a transformer decoder 120, an embedding module 130, an FBEF module 140, and a classification module 150.

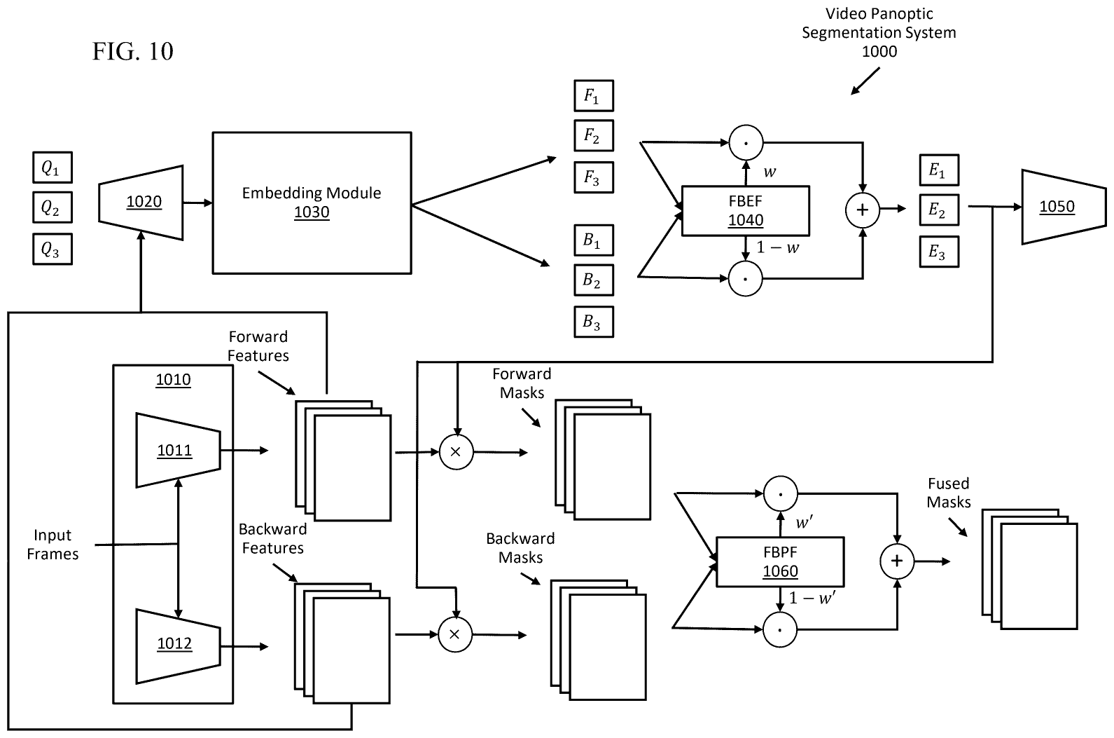

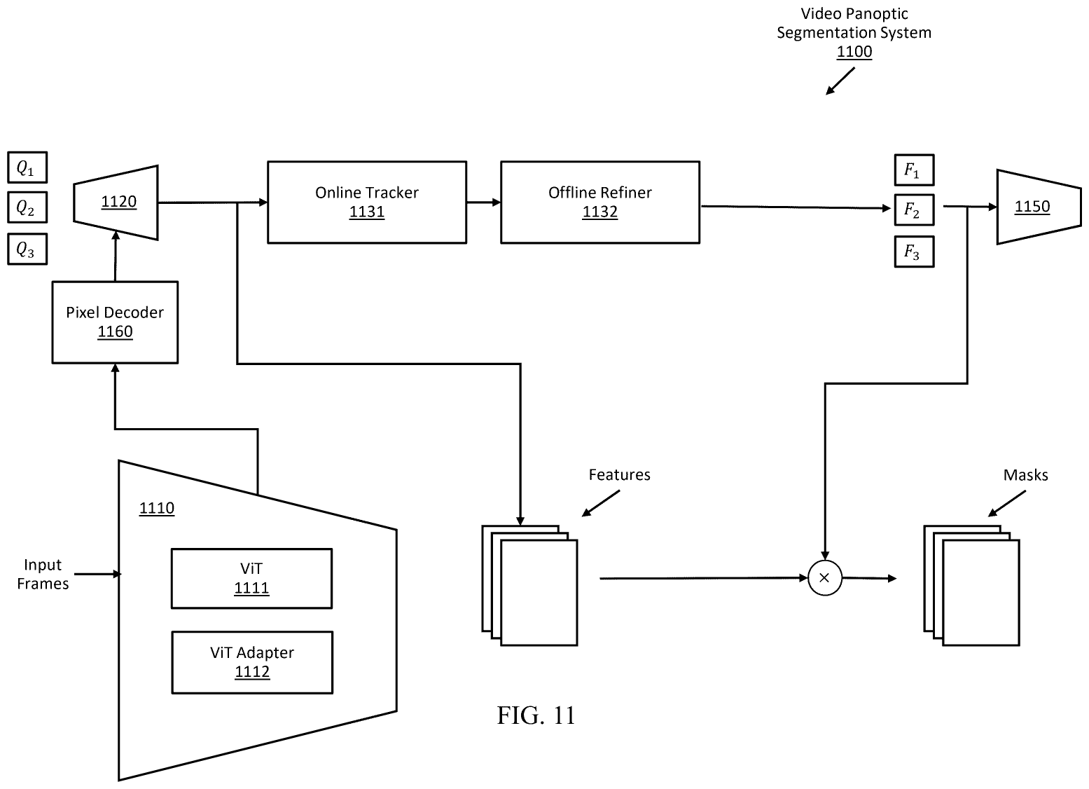

According to embodiments, the system 100 may be a video panoptic segmentation system for performing video segmentation according to a forward and backward embedding fusion (FBEF) approach. For example, during a training stage, embodiments according to the FBEF approach may learn weights to fuse embeddings from both a forward pass and a backward pass of a video to utilize both forward temporal information and backward temporal information based on the embedding features. During an inference stage, embodiments according to the FBEF approach may either use the learned weights or a simple average of the embeddings from both the forward pass and the backward pass. Both may provide improved results in comparison with other approaches. Some embodiments according to the FBEF approach may fuse the forward and backward output predictions obtained from the embeddings instead of, or an addition to, fusing the embeddings. An example of this output prediction fusion is discussed below with reference to FIGS. 10 and 11.

Therefore, in contrast with other approaches, embodiments are directed to an FBEF approach which utilizes both forward and backward temporal information based on forward and backward embedding features. This approach can provide improved performance in comparison with other approaches, for example DVIS offline models.

According to embodiments, input frames of a video may be divided into several clips with a predefined window size, and each clip may be sent to the image encoder 110 to obtain features corresponding to the clip. In embodiments, the image encoder 110 may include at least one of a feature extraction network and a backbone network such as ResNet, Swin, or any other type of network which may be used to obtain image features. Then, initial query embeddings Qᵢ (e.g., Q₁, Q₂, and Q₃ shown in FIG. 1) and the obtained features of each clip may be provided to the transformer decoder 120, which may generate learned query embeddings.

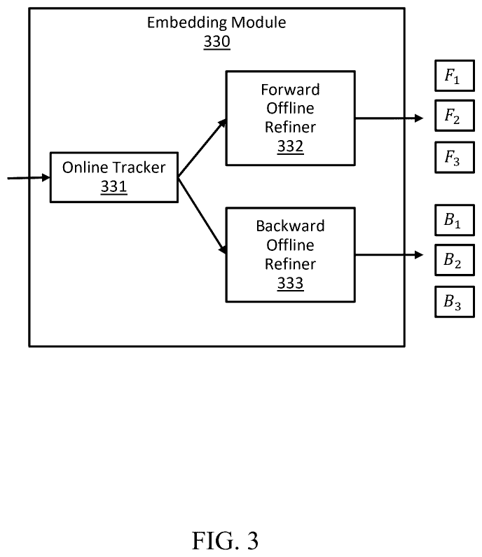

The learned query embeddings may be provided to the embedding module 130, which may generate forward embeddings Fᵢ (e.g., F₁, F₂, and F₃ shown in FIG. 1) and backward embeddings Bᵢ (e.g., B₁, B₂, and B₃ shown in FIG. 1). In embodiments, the embedding module 130 may generate the forward embeddings Fᵢ by refining the initial query embeddings Qᵢ in a forward time order, and may generate the backward embeddings B; by refining the initial query embeddings Qᵢ in a backward time order. For example, the forward time order may correspond to an order of the plurality of frames in a forward time dimension, and the backward time order may correspond to an order of the plurality of frames in a backward time dimension opposite to the forward time dimension. In some embodiments, the forward time order may correspond to an order in which the plurality of frames were captured, but embodiments are not limited thereto. Example operations of the embedding module 130 to generate the forward embeddings Fᵢ and the backward embeddings Bᵢ are described below with reference to FIGS. 3-6.

Both the forward embeddings Fᵢ and the backward embeddings Bᵢ may be provided to the FBEF module 140, which may generate fused embeddings Eᵢ (e.g., E₁, E₂, and E₃ shown in FIG. 1) using fusion weights w. In embodiments, the fused embeddings Et may be obtained according to Equation 1 below:

$${E}_{i} = w * {F}_{i} + ( 1 - w ) * {B}_{i} \qquad ( Equation 1 )$$

Then, the fused embeddings Et may be provided to the classification module 150, which may obtain predicted classifications corresponding to one or more objects included in the video based on the fused embeddings Et. In some embodiments, the classification module 150 may use the fused embeddings Et and the features obtained by the image encoder 110 to generate predicted classification masks which may be applied to one or more frames of the video in order to indicate the class of one or more objects included in the video. For example in some embodiments the predicted classification masks may be generated by multiplying the fused embeddings Et with the features obtained by the image encoder 110, but embodiments are not limited thereto.

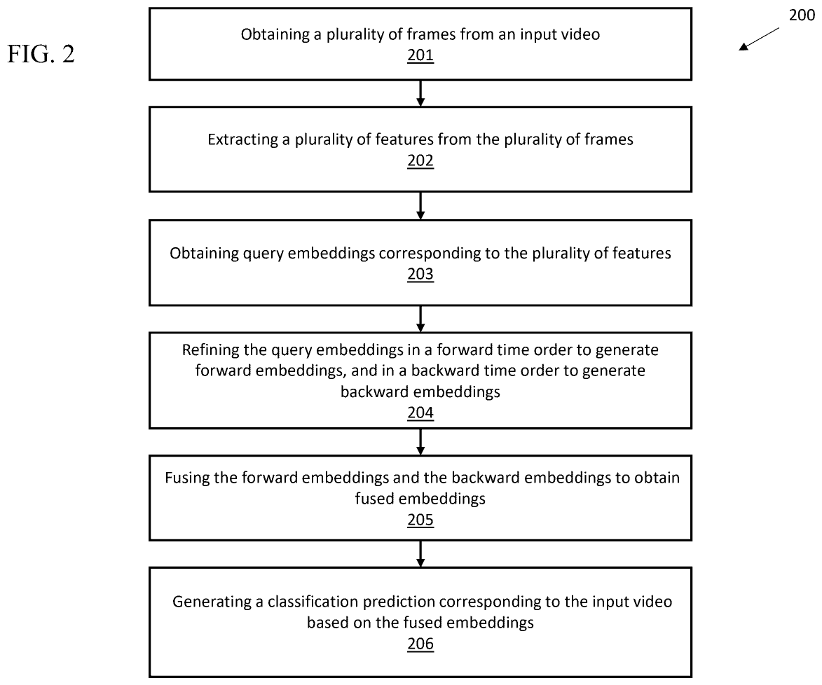

FIG. 2 is a flow chart of an example process 200 for performing image segmentation, according to embodiments. In some implementations, one or more process blocks of FIG. 2 may be performed by any of the elements discussed above, for example one or more of the system 100 and any of the elements included therein.

As shown in FIG. 2, at operation 201 the process 200 may include obtaining a plurality of frames from an input video.

As further shown in FIG. 2, at operation 202 the process 200 may include extracting a plurality of features from the plurality of frames. In embodiments, operation 202 may be performed by the image encoder 110.

As further shown in FIG. 2, at operation 203 the process 200 may include obtaining query embeddings corresponding to the plurality of features. In embodiments, operation 203 may be performed by the transformer decoder 120.

As further shown in FIG. 2, at operation 204 the process 200 may include refining the query embeddings in a forward time order to generate forward embeddings, and refining the query embeddings in a backward time order to generate backward embeddings. In embodiments, operation 204 may be performed by the embedding module 130.

As further shown in FIG. 2, at operation 205 the process 200 may include fusing the forward embeddings and the backward embeddings to obtain fused embeddings. In embodiments, operation 205 may be performed by the FBEF module 140.

As further shown in FIG. 2, at operation 206 the process 200 may include generating a classification prediction corresponding to the input video based on the fused embeddings. In embodiments, operation 206 may be performed by the classification module 150.

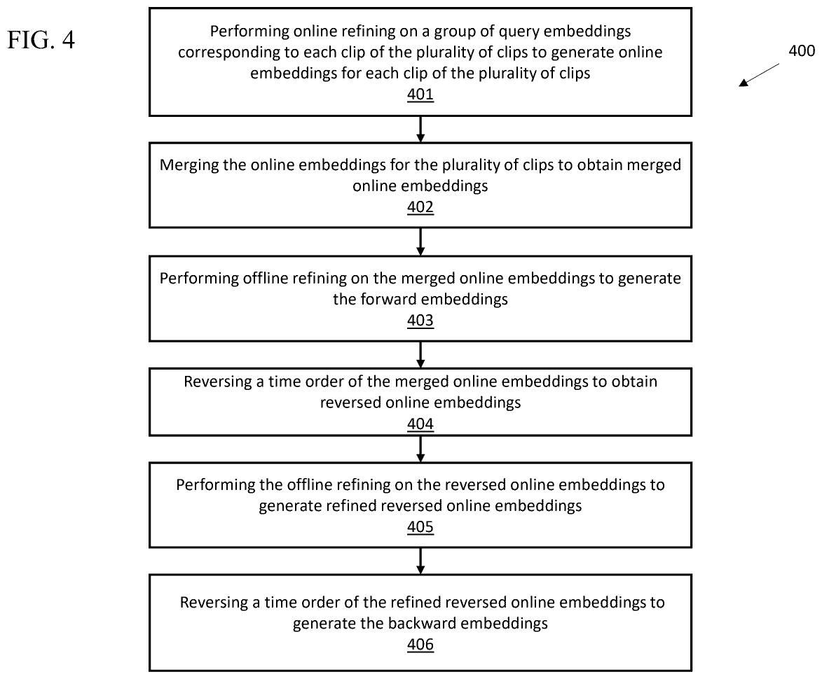

FIG. 3 is a block diagram of an example embedding module 330, according to embodiments. FIG. 4 is a flow chart of an example process 400 for generating embeddings using the embedding module 330 of FIG. 3, according to embodiments. In embodiments, the embedding module 330 may correspond to the embedding module 130 discussed above, and one or more of the operations of process 400 may correspond to operation 204 discussed above. As shown in FIG. 3, the embedding module 330 may include an online tracker 331, which may be used to perform online refining, and also a forward offline refiner 332 and a backward offline refiner 333, which may be used to perform offline refining.

Referring to FIG. 4, at operation 401 the online tracker 331 may be used to generate online embeddings by performing online refining on the query embeddings obtained from the transformer decoder 120. For example, the plurality of frames may be grouped into a plurality of clips, where each clip may correspond to frames within a particular time window. The embedding module 330 may group the query embeddings from frames included in each time window to create a group of query embeddings corresponding to each clip, and the online tracker 331 may refine each group of initial query embeddings to generate online embeddings for each clip. After all of the clips are processed in this way, at operation 402 the embedding module 330 may merge the online embeddings.

In embodiments, the online refining may be performed in a forward time direction, so the merged online embeddings may correspond to the forward time direction. Accordingly, at operation 403, the forward offline refiner 332 may perform offline refining on the merged online embeddings to generate the forward embeddings Fᵢ. The embedding module 330 may reverse a time order of the merged online embeddings to obtain reversed online embeddings at operation 404, and the backward offline refiner 333 may process the reversed online embeddings to generate refined reversed online embeddings at operation 405. Then, at operation 406, the embedding module 330 may reverse a time order of the refined reversed online embeddings to generate the backward embeddings Bᵢ.

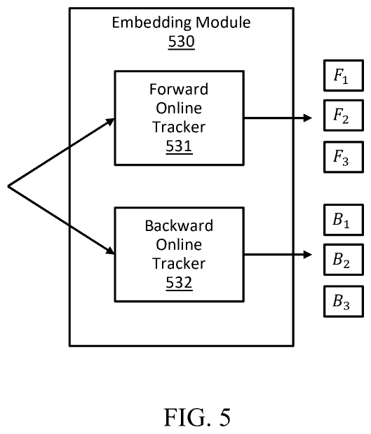

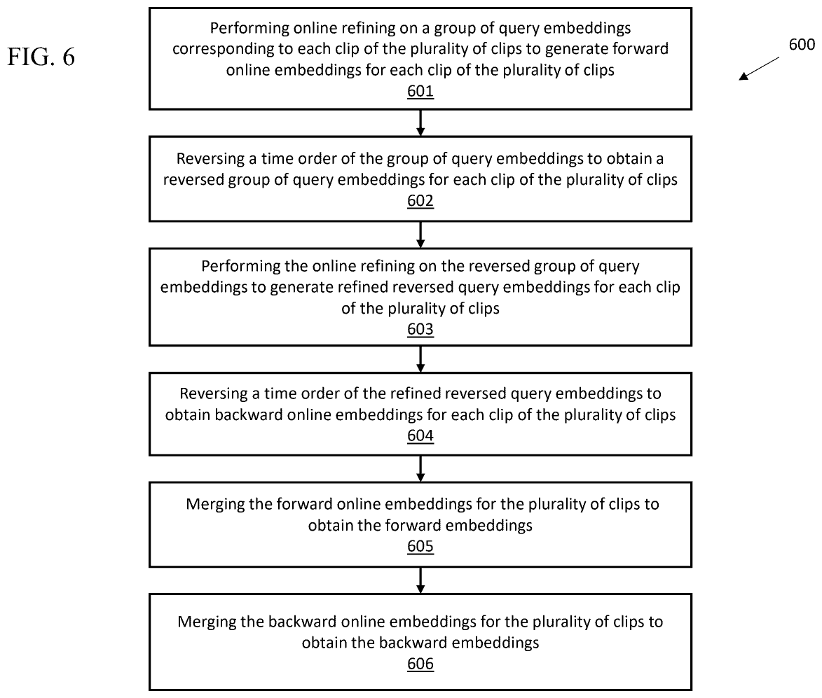

FIG. 5 is a block diagram of an example embedding module 530, according to embodiments. FIG. 6 is a flow chart of an example process 600 for generating embeddings, using the embedding module 530 of FIG. 5, according to embodiments. In embodiments, the embedding module 530 may correspond to the embedding module 130 discussed above, and one or more of the operations of process 600 may correspond to operation 204 discussed above. As shown in FIG. 5, the embedding module 530 may include a forward online tracker 531, and a backward online tracker 532, which may be used to perform online refining.

Referring to FIG. 6, at operation 601 the forward online tracker 531 may be used to generate forward online embeddings by performing online refining on the query embeddings obtained from the transformer decoder 120. For example, as discussed above, the plurality of frames may be grouped into a plurality of clips, where each clip may correspond to frames within a particular time window. The embedding module 530 may group the query embeddings from frames included in each time window to create a group of query embeddings corresponding to each clip, and the forward online tracker 531 may refine each group of query embeddings to generate forward online embeddings for each clip. At operation 602, the embedding module 530 may reverse a time order of the group of query embeddings to obtain a reversed group of query embeddings for each clip. The backward online tracker 532 may perform online refining on the reversed online embeddings to generate refined reversed query embeddings at operation 603, and the embedding module 530 may reverse a time order of the refined reversed query embeddings to obtain backward online embeddings for each clip at operation 604. After all of the clips are processed in this way, the embedding module 530 may merge the forward online embeddings for all of the clips at operation 605 to generate the forward embeddings Fᵢ, and may merge the backward online embeddings for all of the clips at operation 606 to generate the backward embeddings Bᵢ.

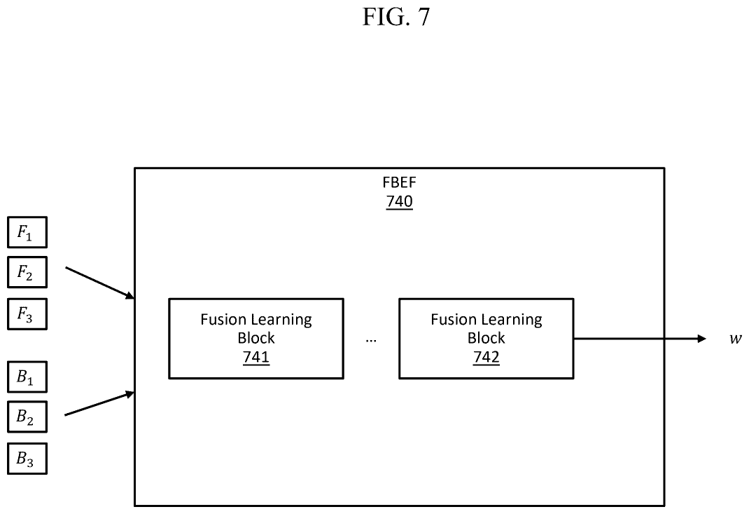

FIG. 7 is a block diagram of an example FBEF module 740, according to embodiments. As shown in FIG. 7, the FBEF module 740 may include one or more fusion learning blocks 741. In embodiments, the FBEF module 740 may correspond to the FBEF module 140 discussed above. In embodiments, the one or more fusion learning blocks 741 may be used to generate the fusion weights w based on the forward embeddings Ft and the backward embeddings Bᵢ.

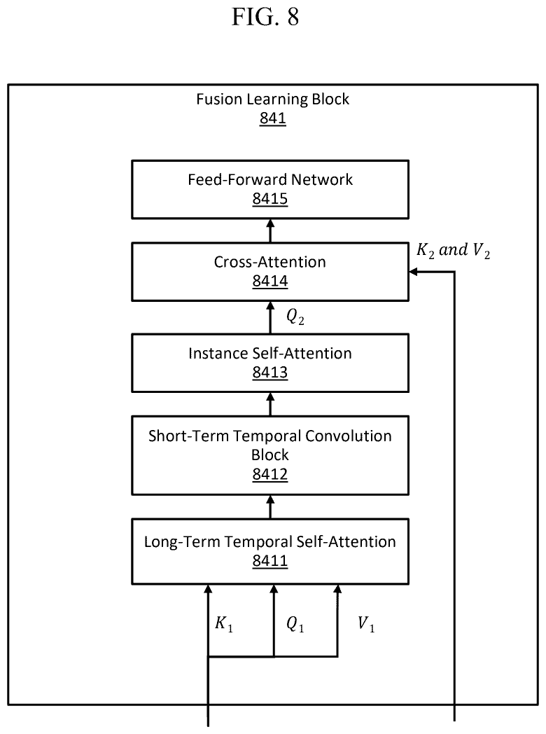

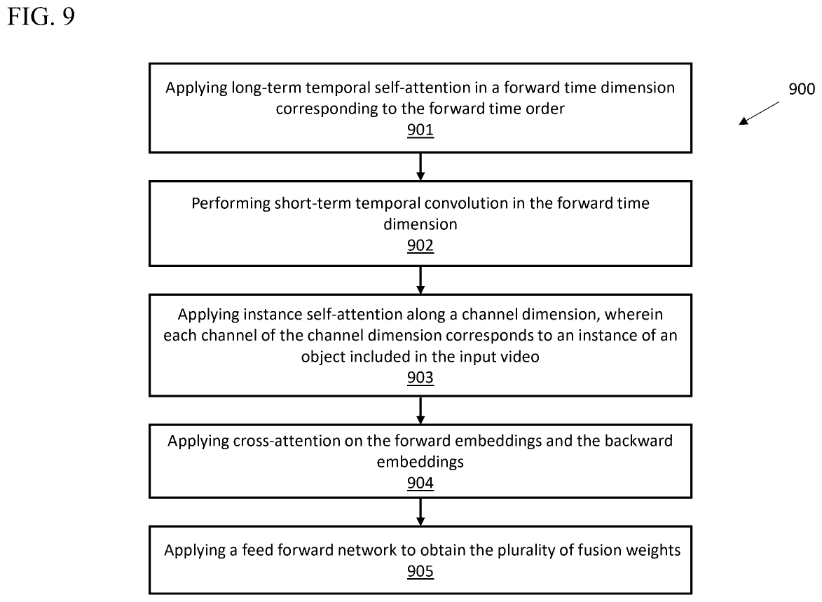

FIG. 8 is a block diagram of an example fusion learning block 841, according to embodiments. FIG. 9 is a flow chart of an example process 900 for generating fusion weights using the fusion learning block 841, according to embodiments. In embodiments, the fusion learning block 841 may correspond to the fusion learning block 741 discussed above, and one or more of the operations of process 900 may correspond to operation 205 discussed above. As shown in FIG. 8, the fusion learning block 841 may include a long-term temporal self-attention module 8411, a short-term temporal convolution module 8412, an instance self-attention module 8413, a cross-attention module 8414, and a feed-forward network module 8415.

As shown in FIG. 9, at operation 901 the process 900 may include applying long-term temporal self-attention processing in a forward time dimension corresponding to the forward time order. For example, the fusion learning block 841 may first keys K₁, first queries Q₁, and first values V₁ corresponding to the forward embeddings Fᵢ and the backward embeddings Bᵢ, and may process them by applying long-term temporal self-attention. For example, in some embodiments, the first keys K₁ and the first queries Q₁ may be, may include, may represent, or may otherwise correspond to the forward embeddings Fᵢ, and the first values V₁ may be, may include, may represent, or may otherwise correspond to updated forward embeddings Fᵢ. In embodiments, operation 901 may be performed by the long-term temporal self-attention module 8411.

As further shown in FIG. 9, at operation 902 the process 900 may include performing short-term temporal convolution in the forward time dimension. In embodiments, the forward time dimension may correspond to a forward time order of the forward embeddings Ft. In embodiments, operation 902 may be performed by the short-term temporal convolution module 8412.

As further shown in FIG. 9, at operation 903 the process 900 may include applying instance self-attention processing along a channel dimension. In embodiments, each channel in the channel dimension may correspond to an instance of an object included in the input video. In some embodiments, the instance self-attention processing may be used to generate second queries Q₂. In embodiments, operation 903 may be performed by the instance self-attention module 8413.

As further shown in FIG. 9, at operation 904 the process 900 may include applying cross-attention processing on the forward embeddings and the backward embeddings. In embodiments, the cross-attention processing may be applied between the forward embeddings Fᵢ and the backward embeddings Bᵢ, for example using the second queries Q₂, as well as second keys K₂ and second values V₂. For example, in some embodiments, the second queries Q₂ may be, may include, may represent, or may otherwise correspond to the backward embeddings Bᵢ, the second keys K₂ may be, may include, may represent, or may otherwise correspond to the forward embeddings Fᵢ, and the second values V₂ may be, may include, may represent, or may otherwise correspond to a result of the cross-attention processing. In embodiments, operation 904 may be performed by the cross-attention module 8414.

As further shown in FIG. 9, at operation 905 the process 900 may include applying a feed forward network to obtain the plurality of fusion weights w. In embodiments, operation 905 may be performed by the feed-forward network module 8415.

Although embodiments are described above in which the forward and backward fusion is performed on embeddings, embodiments are not limited thereto, and in some embodiments the forward and backward fusion may additionally or alternatively be performed on other elements, for example the predicted classification masks discussed above.

FIG. 10 is a block diagram of an example system 1000 for performing image segmentation, according to embodiments. As shown in FIG. 10, the system 1000 may include an image encoder 1010, a transformer decoder 1020, an embedding module 1030, an FBEF module 1040, a classification module 1050, and a forward and backward prediction fusion (FBPF) module 1060. In some embodiments, one or more elements included in the system 1000 may correspond to one or more elements included in the system 100 discussed above, and redundant or duplicative descriptions thereof may be omitted. For example, in some embodiments, the transformer decoder 1020, the embedding module 1030, and the FBEF module 1040 may be substantially similar to the transformer decoder 120, the embedding module 130, and the FBEF module 140 discussed above. However, embodiments are not limited thereto, and in some embodiments these elements may differ.

In embodiments, the image encoder 1010 may be similar to the image encoder 110, and may further include a forward image encoder 1011 configured to generate forward features corresponding to the forward time order, and a backward image encoder 1012 configured to generate backward features corresponding to the backward time order. The classification module 1050 may be similar to the classification module 150 discussed above, and may further generate forward classifications and forward classification masks corresponding to the forward time direction, as well as backward classifications and backward classification masks corresponding to the backward time direction. In embodiments, the FBPF module 1060 may perform a fusion process on the forward predicted classification masks and the backward predicted classification masks in a manner similar to the FBEF module 1040. For example, the FBPF module 1060 may generate fusion weights w′ based on the forward predicted classification masks and the backward predicted classification masks, and may generate fused predicted classification masks based on the fusion weights w′ and the forward predicted classification masks and the backward predicted classification masks. In embodiments, the system 1000 may perform fusion based on the predicted classification masks without performing fusion on the embeddings. For example, the system 1000 may include the FBPF module 1060 and may not include the FBEF module 1040, but embodiments are not limited thereto.

FIG. 11 is a block diagram of an example system 1100 for performing image segmentation, according to embodiments. As shown in FIG. 11, the system 1100 may include an image encoder 1110, a pixel decoder 1160, a transformer decoder 1120, an online tracker 1131, an offline refiner 1132, and a classification module 1150. In some embodiments, one or more elements included in the system 1100 may correspond to one or more elements included in the system 100 or the system 1000 discussed above, and redundant or duplicative descriptions thereof may be omitted. For example, in some embodiments, the transformer decoder 1120 may be substantially similar to the transformer decoder 120 or the transformer decoder 1020, and the classification module 1150 may be substantially similar to the classification module 150 or the classification module 1050, and redundant or duplicative descriptions thereof may be omitted.

Further, in some embodiments, the online tracker 1131 may be substantially similar to one or more of the online tracker 331, the forward online tracker 531, and the backward online tracker 532, and the offline refiner 1132 may be substantially similar to one or more of the forward offline refiner 332 and the backward offline refiner 333. However, embodiments are not limited thereto, and in some embodiments these elements may differ.

According embodiments, input frames of a video may be divided into several clips with a predefined window size, and each clip may be sent to the image encoder 1110. The image encoder 1110 may include a visual transformer (ViT) 1111 and a ViT adapter 1112. The clips may be processed using the ViT 111 and the ViT adapter 1112, and then may be provided to the pixel decoder 1160 to generate multiple-scale features. The initial query embeddings Qᵢ (e.g., Q₁, Q₂, and Q₃ shown in FIG. 11) and the obtained multiple-scale features may be provided to the transformer decoder 1120, which may generate learned query embeddings and the final features.

The learned query embeddings may be provided to the online tracker 1131, which may further refine the query embeddings of each clip, and then all of the query embeddings for different clips may be merge them together as the overall query embeddings for the whole video. The overall query embeddings may be passed to the offline refiner 1132, which may generate the embeddings Fᵢ (e.g., F₁, F₂, and F₃ shown in FIG. 11). The embeddings Fᵢ may be provided to the classification module 1150, which may obtain predicted classifications corresponding to one or more objects included in the video based on the embeddings Fᵢ. In some embodiments, the classification module 1150 may use the embeddings Fᵢ and the features obtained by the image encoder 1110 to generate predicted classification masks which may be applied to one or more frames of the video in order to indicate the class of one or more objects included in the video. For example in some embodiments the predicted classification masks may be generated by multiplying the embeddings Fᵢ with the features obtained by the image encoder 1110, but embodiments are not limited thereto.

Although the system 1100 is shown in FIG. 11 as including only one online tracker 1131 and one offline refiner 1132, embodiments are not limited thereto. For example, in some embodiments, the system 1100 may include an embedding module (e.g., the embedding module 130, the embedding module 330, the embedding module 530, and the embedding module 1030), which may include forward and backward online trackers and/or forward and backward offline refiners, and may also include an FBEF module (e.g., the FBEF module 140, the FBEF module 740, and the FBEF module 1040). Accordingly, the classification module 1150 may obtain the predicted classifications such as the classification based on the fused embeddings Eᵢ, as discussed above.

According to embodiments, the VIT 1111 may be a large visual foundation model ViT-g such as DINOv2-g, which may be trained using a training method such as DINOv2. For example, DINOv2-g may be large visual foundation model that has 1.1 billion parameters. In embodiments, DINOv2-g may be a plain ViT architecture that may not have multiple-scale features. However, multiple-scale features may be useful for segmentation tasks. As a result, the image encoder 1110 may include the ViT adapter 1112, which may be used together with the ViT 1111 to generate multiple-scale features.

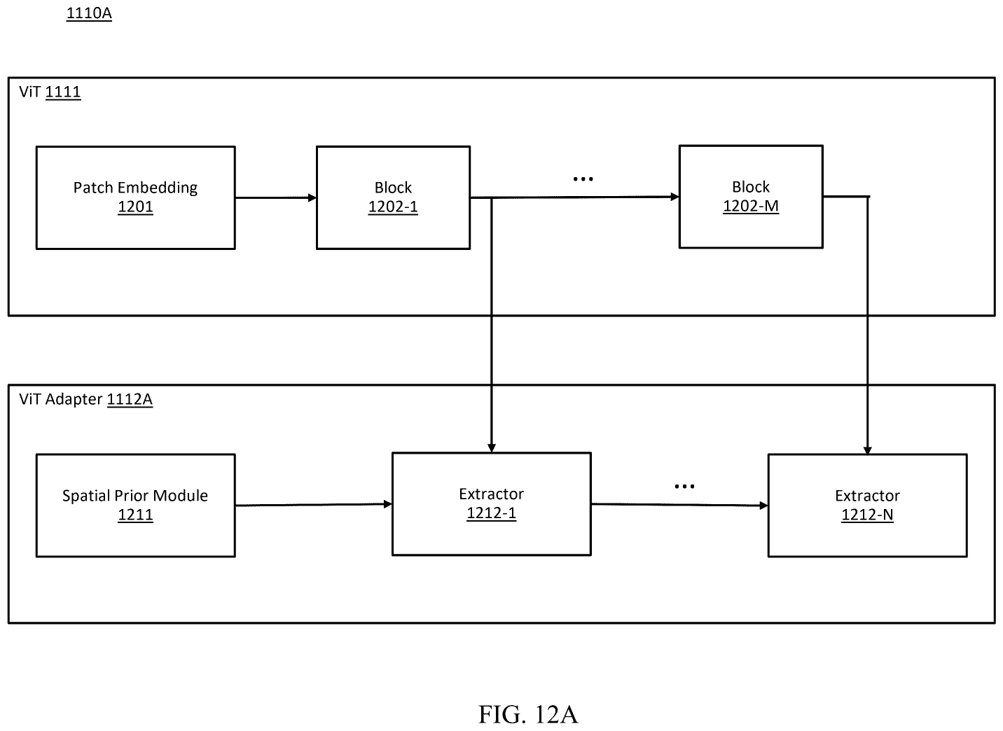

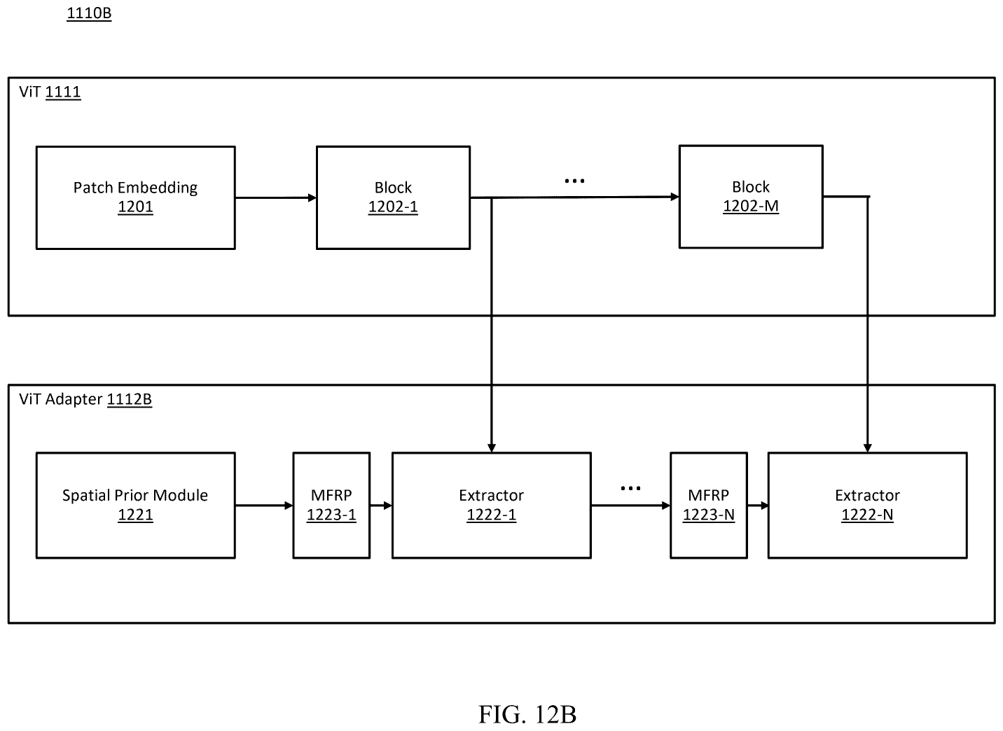

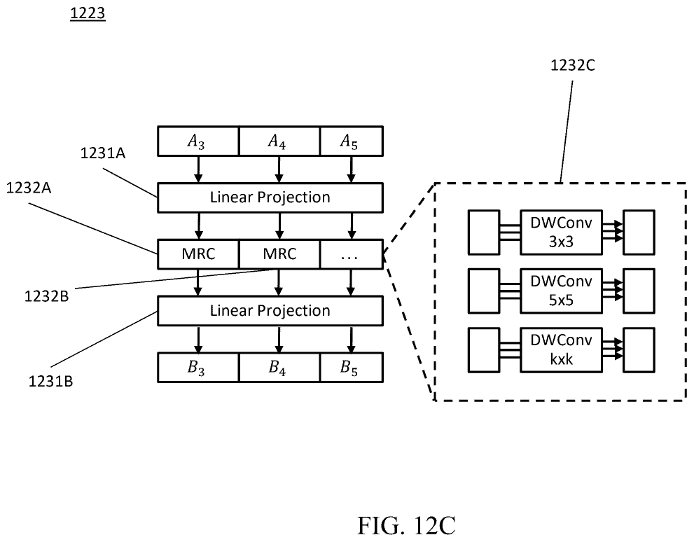

FIG. 12A is a block diagram of an example image encoder 1110A, which may include the VIT 1111 and a ViT adapter 1112A. In embodiments, the image encoder 1110A may correspond to the image encoder 1110, and the ViT adapter 1112A may be an example of the ViT adapter 1112.

According to embodiments, the VIT 1111 may include a patch embedding module 1201 and one or more blocks 1202 (e.g., first block 1202-1 through Mth block 1202-M). The ViT adapter 1112A may include a spatial prior module 1211 and one or more extractors 1212 (e.g., a first extractor 1212-1 through an Nth extractor 1212-N, as shown in FIG. 12A). In embodiments, the spatial prior module 1221 may include a plurality of strided convolution layers. For example, the spatial prior module may receive the image as input, and may output a concatenation of flattened multiple-scale features.

As an example, the VIT 1111 (e.g., the ViT-g) may include forty blocks, which may be divided evenly into four stages by indices [[0, 9], [10, 19], [20, 29], [30, 39]], and the output of each stage may interact with a corresponding extractor 1212 of the ViT adapter 1112A. For example, a first stage may correspond to a zeroth block 1202 through a ninth block 1202, and the output of the ninth block 1202 may interact with a first extractor 1212. Similarly, a second stage may correspond to a tenth block 1202 through a nineteenth block 1202, and the output of the nineteenth block 1202 may interact with a second extractor 1212; a third stage may correspond to a twentieth block 1202 through a twenty-ninth block 1202, and the output of the twenty-ninth block 1202 may interact with a third extractor 1212; and a fourth stage may correspond to a thirtieth block 1202 through a thirty-ninth block 1202, and the output of the thirty-ninth block 1202 may interact with a fourth extractor 1212 . . . . The extractors 1212 may interact with the frozen ViT 1111 at the chosen indices of the blocks 1202. Each extractor 1222 may receive two inputs, for example one in from the spatial prior module 1221 or a previous extractor 1212, and another input from the output of a stage of the VIT 1111. The final output of the Nth extractor 1222-N may be split for each scale, and fed into the pixel decoder 1160.

FIG. 12B is a block diagram of an example image encoder 1110B, which may include the VIT 1111 and a ViT adapter 1112B. In embodiments, the image encoder 1110B may correspond to the image encoder 1110, and the ViT adapter 1112B may be an example of the ViT adapter 1112. The ViT adapter 1112B may include a spatial prior module 1221 and one or more extractors 1212 (e.g., a first extractor 1212-1 through an Nth extractor 1212-N, as shown in FIG. 12A). In embodiments, the spatial prior module 1221 may be substantially similar to the spatial prior module 1211, and the one or more extractors 1222 may be substantially similar to the one or more extractors 1212. However, embodiments are not limited thereto, and in some embodiments these elements may differ.

According to embodiments, the ViT adapter 1112B may further include one or more multi-receptive field feature pyramid (MRFP) modules 1223 (e.g., MFRP module 1223-1 through Nth MFRP module 1223-N) which may be inserted before each extractor module 1222. In embodiments, the MFRP module modules 1223 may include a feature pyramid and multi-receptive field convolutional (MRC) layers. The feature pyramid may provide rich multiple-scale information, while the MRC layers may expand the receptive field using different convolution kernels, which may enhance the long-range modeling ability of features such as convolutional neural network (CNN) features. For example, the ViT adapter 1112B may be based on a vision transformer with convolutional multiple-scale feature interaction (ViT-CoMer).

FIG. 12C is a block diagram of an example of an MFRP module 1223, according to embodiments. In embodiments, the MFRP module 1223 shown in FIG. 12C may include one or more linear projection layers 1231 (e.g., linear projection layer 1231A and linear projection layer 1231B) and one or more MRC modules 1232 (e.g, MRC module 1232A, MRC module 1232B, and MRC module 1232C). The MFRP module 1223 may receive as input a set of multiple-scale features A (e.g., A₁, A₂, and A₃ shown in FIG. 12C), which may be flattened and concatenated into feature tokens. The feature tokens may first pass through the linear projection layer 1231A to obtain dimensionally reduced features, and then the features may divided into a plurality of groups on the channel dimension. Different groups of features may correspond to convolutional layers with different receptive fields. For example, as shown with respect to MRC module 1232C, the MRC modules 1232 may include depthwise convolution modules DWConv which may perform depth-wise convolution operations with different kernel sizes (e.g., 3×3, 5×5, k×k, etc.). Then, the processed features may be concatenated and dimensionally increased using the linear projection layer 1231B, and output as output features B (e.g., B₁, B₂, and B₃ shown in FIG. 12C). Therefore, according to embodiments, a large visual foundation model such as DINOv2-g may be integrated into a DVIS framework using a ViT adapter, which may improve performance of a DVIS offline model. In addition, according to embodiments, a ViT-CoMer based ViT adapter may combine an MFRP module into the ViT adapter to provide improved multiple-scale features.

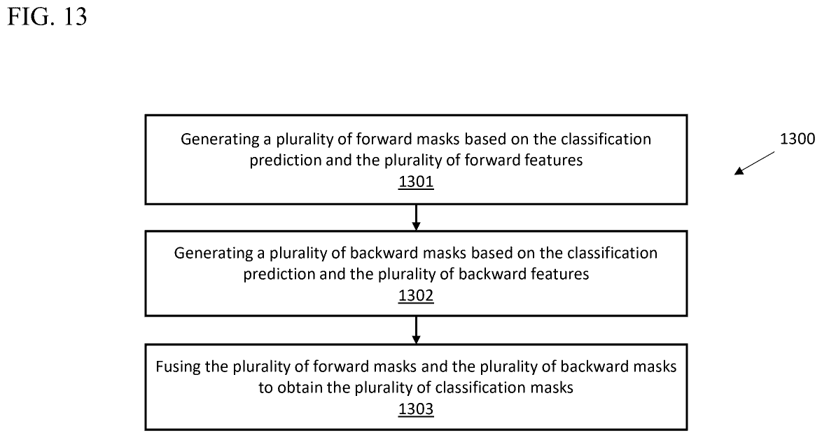

FIG. 13 is a flow chart of an example process 1300 for performing image segmentation using the system 1000, according to embodiments. In embodiments, one or more of the operations of process 1300 may correspond to operation 206 discussed above.

As shown in FIG. 13 at operation 1301 the process 1300 may include generating a plurality of forward masks based on the classification prediction and the plurality of forward features. In embodiments, operation 1301 may be performed by the forward image encoder 1011.

As further shown in FIG. 13, at operation 1302 the process 1300 may include generating a plurality of backward masks based on the classification prediction and the plurality of backward features. In embodiments, operation 1302 may be performed by the backward image encoder 1012.

As further shown in FIG. 13, at operation 1303 the process 1300 may include fusing the plurality of forward masks and the plurality of backward masks to obtain the plurality of classification masks. In embodiments, operation 1303 may be performed by the classification module 1050.

Although FIGS. 2, 4, 6, 9, and 13 show example blocks of processes 200, 400, 600, 900, and 1300, in some implementations, the processes 200, 400, 600, 900, and 1300 may include additional blocks, fewer blocks, different blocks, or differently arranged blocks than those depicted in FIGS. 2, 4, 6, 9, and 13. Additionally, or alternatively, two or more of the blocks of the processes 200, 400, 600, 900, and 1300 may be arranged or combined in any order, or performed in parallel.

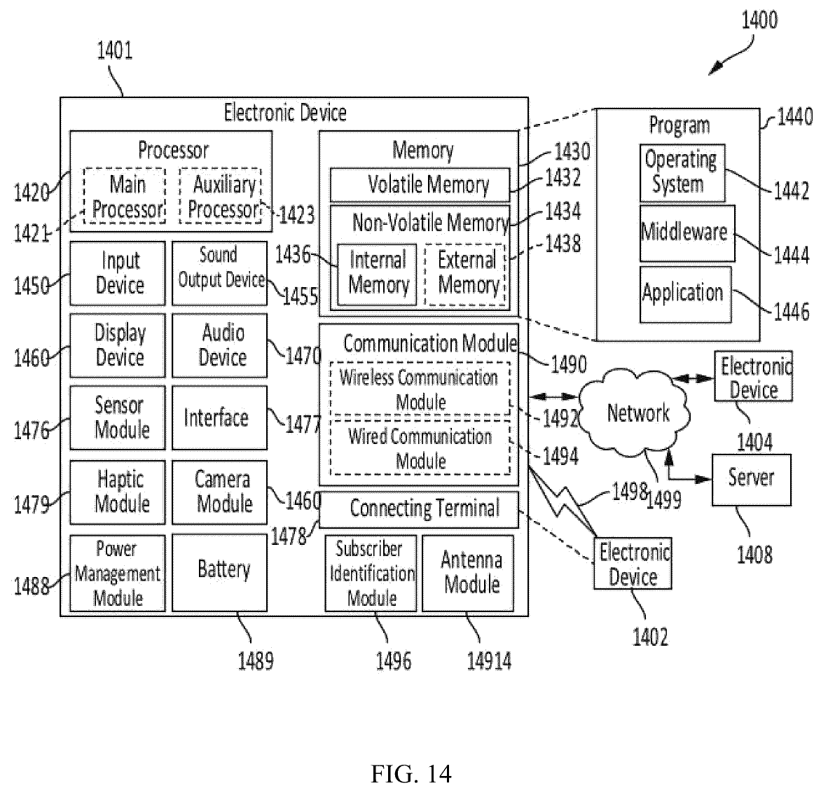

FIG. 14 is a block diagram of an electronic device in a network environment 1400, according to an embodiment.

Referring to FIG. 14, an electronic device 1401 in a network environment 1400 may communicate with an electronic device 1402 via a first network 1498 (e.g., a short-range wireless communication network), or an electronic device 1404 or a server 1408 via a second network 1499 (e.g., a long-range wireless communication network). The electronic device 1401 may communicate with the electronic device 1404 via the server 1408. The electronic device 1401 may include a processor 1420, a memory 1430, an input device 1450, a sound output device 1455, a display device 1460, an audio module 1470, a sensor module 1476, an interface 1477, a haptic module 1479, a camera module 1480, a power management module 1488, a battery 1489, a communication module 1490, a subscriber identification module (SIM) card 1496, or an antenna module 1497. In one embodiment, at least one (e.g., the display device 1460 or the camera module 1480) of the components may be omitted from the electronic device 1401, or one or more other components may be added to the electronic device 1401. Some of the components may be implemented as a single integrated circuit (IC). For example, the sensor module 1476 (e.g., a fingerprint sensor, an iris sensor, or an illuminance sensor) may be embedded in the display device 1460 (e.g., a display).

The processor 1420 may execute software (e.g., a program 1440) to control at least one other component (e.g., a hardware or a software component) of the electronic device 1401 coupled with the processor 1420 and may perform various data processing or computations. For example, in some embodiments one or more operations of processes 200, 400, 600, 900, and 1300 may be performed by the processor 1420 based on instructions stored in the memory 930.

As at least part of the data processing or computations, the processor 1420 may load a command or data received from another component (e.g., the sensor module 1476 or the communication module 1490) in volatile memory 1432, process the command or the data stored in the volatile memory 1432, and store resulting data in non-volatile memory 1434. The processor 1420 may include a main processor 1421 (e.g., a central processing unit (CPU) or an application processor (AP)), and an auxiliary processor 1423 (e.g., a graphics processing unit (GPU), an image signal processor (ISP), a sensor hub processor, or a communication processor (CP)) that is operable independently from, or in conjunction with, the main processor 1421. Additionally or alternatively, the auxiliary processor 1423 may be adapted to consume less power than the main processor 1421, or execute a particular function. The auxiliary processor 1423 may be implemented as being separate from, or a part of, the main processor 1421.

The auxiliary processor 1423 may control at least some of the functions or states related to at least one component (e.g., the display device 1460, the sensor module 1476, or the communication module 1490) among the components of the electronic device 1401, instead of the main processor 1421 while the main processor 1421 is in an inactive (e.g., sleep) state, or together with the main processor 1421 while the main processor 1421 is in an active state (e.g., executing an application). The auxiliary processor 1423 (e.g., an image signal processor or a communication processor) may be implemented as part of another component (e.g., the camera module 1480 or the communication module 1490) functionally related to the auxiliary processor 1423.

The memory 1430 may store various data used by at least one component (e.g., the processor 1420 or the sensor module 1476) of the electronic device 1401. The various data may include, for example, software (e.g., the program 1440) and input data or output data for a command related thereto. The memory 1430 may include the volatile memory 1432 or the non-volatile memory 1434. Non-volatile memory 1434 may include internal memory 1436 and/or external memory 1438.

The program 1440 may be stored in the memory 1430 as software, and may include, for example, an operating system (OS) 1442, middleware 1444, or an application 1446.

The input device 1450 may receive a command or data to be used by another component (e.g., the processor 1420) of the electronic device 1401, from the outside (e.g., a user) of the electronic device 1401. The input device 1450 may include, for example, a microphone, a mouse, or a keyboard.

The sound output device 1455 may output sound signals to the outside of the electronic device 1401. The sound output device 1455 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1460 may visually provide information to the outside (e.g., a user) of the electronic device 1401. The display device 1460 may include, for example, a display, a hologram device, or a projector and control circuitry to control a corresponding one of the display, hologram device, and projector. The display device 1460 may include touch circuitry adapted to detect a touch, or sensor circuitry (e.g., a pressure sensor) adapted to measure the intensity of force incurred by the touch.

The audio module 1470 may convert a sound into an electrical signal and vice versa. The audio module 1470 may obtain the sound via the input device 1450 or output the sound via the sound output device 1455 or a headphone of an external electronic device 1402 directly (e.g., wired) or wirelessly coupled with the electronic device 1401.

The sensor module 1476 may detect an operational state (e.g., power or temperature) of the electronic device 1401 or an environmental state (e.g., a state of a user) external to the electronic device 1401, and then generate an electrical signal or data value corresponding to the detected state. The sensor module 1476 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1477 may support one or more specified protocols to be used for the electronic device 1401 to be coupled with the external electronic device 1402 directly (e.g., wired) or wirelessly. The interface 1477 may include, for example, a high-definition multimedia interface (HDMI), a universal serial bus (USB) interface, a secure digital (SD) card interface, or an audio interface.

A connecting terminal 1478 may include a connector via which the electronic device 1401 may be physically connected with the external electronic device 1402. The connecting terminal 1478 may include, for example, an HDMI connector, a USB connector, an SD card connector, or an audio connector (e.g., a headphone connector).

The haptic module 1479 may convert an electrical signal into a mechanical stimulus (e.g., a vibration or a movement) or an electrical stimulus which may be recognized by a user via tactile sensation or kinesthetic sensation. The haptic module 1479 may include, for example, a motor, a piezoelectric element, or an electrical stimulator.

The camera module 1480 may capture a still image or moving images. The camera module 1480 may include one or more lenses, image sensors, image signal processors, or flashes. The power management module 1488 may manage power supplied to the electronic device 1401. The power management module 1488 may be implemented as at least part of, for example, a power management integrated circuit (PMIC). In embodiments, the input video may be captured by the camera module 1480, but embodiments are not limited thereto.

The battery 1489 may supply power to at least one component of the electronic device 1401. The battery 1489 may include, for example, a primary cell which is not rechargeable, a secondary cell which is rechargeable, or a fuel cell.

The communication module 1490 may support establishing a direct (e.g., wired) communication channel or a wireless communication channel between the electronic device 1401 and the external electronic device (e.g., the electronic device 1402, the electronic device 1404, or the server 1408) and performing communication via the established communication channel. The communication module 1490 may include one or more communication processors that are operable independently from the processor 1420 (e.g., the AP) and supports a direct (e.g., wired) communication or a wireless communication. The communication module 1490 may include a wireless communication module 1492 (e.g., a cellular communication module, a short-range wireless communication module, or a global navigation satellite system (GNSS) communication module) or a wired communication module 1494 (e.g., a local area network (LAN) communication module or a power line communication (PLC) module). A corresponding one of these communication modules may communicate with the external electronic device via the first network 1498 (e.g., a short-range communication network, such as BLUETOOTH™, wireless-fidelity (Wi-Fi) direct, or a standard of the Infrared Data Association (IrDA)) or the second network 1499 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1492 may identify and authenticate the electronic device 1401 in a communication network, such as the first network 1498 or the second network 1499, using subscriber information (e.g., international mobile subscriber identity (IMSI)) stored in the subscriber identification module 1496.

The antenna module 1497 may transmit or receive a signal or power to or from the outside (e.g., the external electronic device) of the electronic device 1401. The antenna module 1497 may include one or more antennas, and, therefrom, at least one antenna appropriate for a communication scheme used in the communication network, such as the first network 1498 or the second network 1499, may be selected, for example, by the communication module 1490 (e.g., the wireless communication module 1492). The signal or the power may then be transmitted or received between the communication module 1490 and the external electronic device via the selected at least one antenna.

Commands or data may be transmitted or received between the electronic device 1401 and the external electronic device 1404 via the server 1408 coupled with the second network 1499. Each of the electronic devices 1402 and 1404 may be a device of a same type as, or a different type, from the electronic device 1401. All or some of operations to be executed at the electronic device 1401 may be executed at one or more of the external electronic devices 1402, 1404, or 1408. For example, if the electronic device 1401 should perform a function or a service automatically, or in response to a request from a user or another device, the electronic device 1401, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1401. The electronic device 1401 may provide the outcome, with or without further processing of the outcome, as at least part of a reply to the request. To that end, a cloud computing, distributed computing, or client-server computing technology may be used, for example.

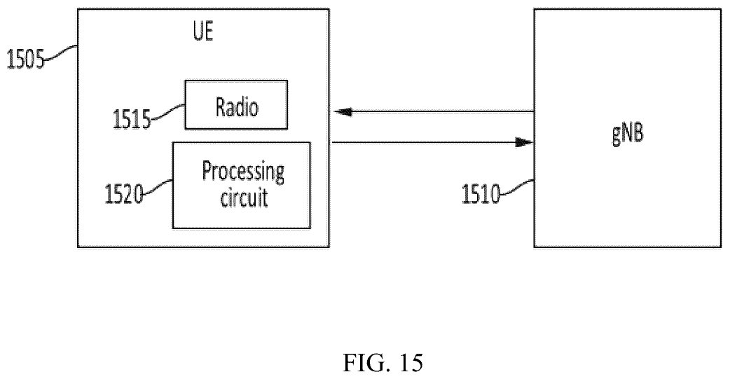

FIG. 15 shows a system including a UE 1505 and a gNB 1510, in communication with each other. The UE may include a radio 1515 and a processing circuit (or a means for processing) 1520, which may perform various methods disclosed herein, e.g., the method illustrated in FIG. 1. For example, the processing circuit 1520 may receive, via the radio 1515, transmissions from the network node (gNB) 1510, and the processing circuit 1520 may transmit, via the radio 1515, signals to the gNB 1510.

Embodiments of the subject matter and the operations described in this specification may be implemented in digital electronic circuitry, or in computer software, firmware, or hardware, including the structures disclosed in this specification and their structural equivalents, or in combinations of one or more of them. Embodiments of the subject matter described in this specification may be implemented as one or more computer programs, i.e., one or more modules of computer-program instructions, encoded on computer-storage medium for execution by, or to control the operation of data-processing apparatus. Alternatively or additionally, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer-storage medium can be, or be included in, a computer-readable storage device, a computer-readable storage substrate, a random or serial-access memory array or device, or a combination thereof. Moreover, while a computer-storage medium is not a propagated signal, a computer-storage medium may be a source or destination of computer-program instructions encoded in an artificially-generated propagated signal. The computer-storage medium can also be, or be included in, one or more separate physical components or media (e.g., multiple CDs, disks, or other storage devices). Additionally, the operations described in this specification may be implemented as operations performed by a data-processing apparatus on data stored on one or more computer-readable storage devices or received from other sources.

While this specification may contain many specific implementation details, the implementation details should not be construed as limitations on the scope of any claimed subject matter, but rather be construed as descriptions of features specific to particular embodiments. Certain features that are described in this specification in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described herein. Other embodiments are within the scope of the following claims. In some cases, the actions set forth in the claims may be performed in a different order and still achieve desirable results. Additionally, the processes depicted in the accompanying figures do not necessarily require the particular order shown, or sequential order, to achieve desirable results. In certain implementations, multitasking and parallel processing may be advantageous.

As will be recognized by those skilled in the art, the innovative concepts described herein may be modified and varied over a wide range of applications. Accordingly, the scope of claimed subject matter should not be limited to any of the specific exemplary teachings discussed above, but is instead defined by the following claims.

1. A method of performing video segmentation, the method comprising:
obtaining a plurality of frames from an input video;
extracting a plurality of features from the plurality of frames;
obtaining query embeddings corresponding to the plurality of features;
refining the query embeddings in a forward time order to generate forward embeddings, and in a backward time order to generate backward embeddings;
fusing the forward embeddings and the backward embeddings to obtain fused embeddings; and
generating a classification prediction corresponding to the input video based on the fused embeddings.

2. The method of claim 1, wherein the plurality of frames are divided into a plurality of clips, and
wherein the refining comprises:
performing online refining on a group of query embeddings corresponding to each clip of the plurality of clips to generate online embeddings for each clip of the plurality of clips;
merging the online embeddings for the plurality of clips to obtain merged online embeddings;
performing offline refining on the merged online embeddings to generate the forward embeddings;
reversing a time order of the merged online embeddings to obtain reversed online embeddings;
performing the offline refining on the reversed online embeddings to generate refined reversed online embeddings; and
reversing a time order of the refined reversed online embeddings to generate the backward embeddings.

3. The method of claim 1, wherein the plurality of frames are divided into a plurality of clips, and
wherein the refining comprises:
performing online refining on a group of query embeddings corresponding to each clip of the plurality of clips to generate forward online embeddings for each clip of the plurality of clips;
reversing a time order of the group of query embeddings to obtain a reversed group of query embeddings for each clip of the plurality of clips;
performing the online refining on the reversed group of query embeddings to generate refined reversed query embeddings for each clip of the plurality of clips;
reversing a time order of the refined reversed query embeddings to obtain backward online embeddings for each clip of the plurality of clips;
merging the forward online embeddings for the plurality of clips to obtain the forward embeddings; and
merging the backward online embeddings for the plurality of clips to obtain the backward embeddings.

4. The method of claim 1, wherein the fusing comprises generating a plurality of fusion weights using a fusion module comprising a plurality of fusion learning blocks.

5. (canceled)

6. The method of claim 4, wherein for each fusion learning block of the plurality of fusion learning blocks, the fusing comprises:
applying long-term temporal self-attention in a forward time dimension corresponding to the forward time order;
performing short-term temporal convolution in the forward time dimension;
applying instance self-attention along a channel dimension, wherein each channel of the channel dimension corresponds to an instance of an object included in the input video;
applying cross-attention on the forward embeddings and the backward embeddings; and
applying a feed forward network to obtain the plurality of fusion weights.

7. The method of claim 1, further comprising generating a plurality of classification masks corresponding to the input video based on the classification prediction and the plurality of features.

8. The method of claim 7, wherein the plurality of features comprises a plurality of forward features corresponding to the forward time order and a plurality of backward features corresponding to the backward time order, and
wherein the method further comprises:
generating a plurality of forward masks based on the classification prediction and the plurality of forward features;
generating a plurality of backward masks based on the classification prediction and the plurality of backward features; and
fusing the plurality of forward masks and the plurality of backward masks to obtain the plurality of classification masks.

9. The method of claim 1, wherein the features are extracted using an image encoder comprising a visual transformer model, and a visual transformer adapter configured to generate multiple-scale features based on an output of the visual transformer model.

10. (canceled)

11. A system for performing video segmentation, the system comprising:
an image encoder configured to extract a plurality of features from a plurality of frames included in an input video;
a transformer decoder configured to obtain query embeddings corresponding to the plurality of features;
an embedding module configured to refine the query embeddings in a forward time order to generate forward embeddings, and in a backward time order to generate backward embeddings;
a fusion module configured to fuse the forward embeddings and the backward embeddings to obtain fused embeddings; and
a classification module configured to generate a classification prediction corresponding to the input video based on the fused embeddings.

12. The system of claim 11, wherein the plurality of frames are divided into a plurality of clips,
wherein the embedding module comprises an online tracking module configured to refine a group of query embeddings corresponding to each clip of the plurality of clips to generate online embeddings for each clip of the plurality of clips,
wherein the embedding module is further configured to merge the online embeddings for the plurality of clips to obtain merged online embeddings, and to reverse a time order of the merged online embeddings to obtain reversed online embeddings,
wherein the embedding module further comprises:
a forward offline refiner configured to refine the merged online embeddings to generate the forward embeddings; and
a backward offline refiner configured to refine the reversed online embeddings to generate refined reversed online embeddings, and
wherein the embedding module is further configured to reverse a time order of the refined reversed online embeddings to generate the backward embeddings.

13. The system of claim 11, wherein the plurality of frames are divided into a plurality of clips,
wherein the embedding module comprises a forward online tracking module configured to refine a group of query embeddings corresponding to each clip of the plurality of clips to generate forward online embeddings for each clip of the plurality of clips,
wherein the embedding module is further configured to reverse a time order of the of the group of query embeddings to obtain a reversed group of query embeddings for each clip of the plurality of clips,
wherein the embedding module further comprises a backward online tracking module configured to refine the reversed group of query embeddings to generate refined reversed query embeddings for each clip of the plurality of clips, and
wherein the embedding module is further configured to:
reverse a time order of the refined reversed query embeddings to obtain backward online embeddings for each clip of the plurality of clips;
merge the forward online embeddings for the plurality of clips to obtain the forward embeddings; and
merge the backward online embeddings for the plurality of clips to obtain the backward embeddings.

14. The system of claim 11, wherein the fusion module is further configured to generate a plurality of fusion weights using a plurality of fusion learning blocks.

15. (canceled)

16. The system of claim 14, wherein each fusion learning block of the plurality of fusion learning blocks is configured to:
apply long-term temporal self-attention in a forward time dimension corresponding to the forward time order;
perform short-term temporal convolution in the forward time dimension;
apply instance self-attention along a channel dimension, wherein each channel of the channel dimension corresponds to an instance of an object included in the input video;
apply cross-attention on the forward embeddings and the backward embeddings; and
apply a feed forward network to obtain the plurality of fusion weights.

17. The system of claim 11, wherein the classification module is further configured to generate a plurality of classification masks corresponding to the input video based on the classification prediction and the plurality of features.

18. The system of claim 17, wherein the plurality of features comprises a plurality of forward features corresponding to the forward time order and a plurality of backward features corresponding to the backward time order, and
wherein the classification module is further configured to:
generate a plurality of forward masks based on the classification prediction and the plurality of forward features;
generate a plurality of backward masks based on the classification prediction and the plurality of backward features; and
fuse the plurality of forward masks and the plurality of backward masks to obtain the plurality of classification masks.

19. The system of claim 11, wherein the image encoder comprises a visual transformer model, and a visual transformer adapter configured to generate multiple-scale features based on an output of the visual transformer model.

20. (canceled)

21. A non-transitory computer-readable medium storing instructions which, when executed by at least one processor of a device for performing video segmentation, causes the at least one processor to:
obtain a plurality of frames from an input video;
extract a plurality of features from the plurality of frames;
obtain query embeddings corresponding to the plurality of features;
refine the query embeddings in a forward time order to generate forward embeddings, and in a backward time order to generate backward embeddings;
fuse the forward embeddings and the backward embeddings to obtain fused embeddings; and
generate a classification prediction corresponding to the input video based on the fused embeddings.

22. The non-transitory computer-readable medium of claim 21, wherein the plurality of frames are divided into a plurality of clips, and
wherein to perform the refining, the instructions further cause the at least one processor to:
perform online refining on a group of query embeddings corresponding to each clip of the plurality of clips to generate online embeddings for each clip of the plurality of clips;
merge the online embeddings for the plurality of clips to obtain merged online embeddings;
perform offline refining on the merged online embeddings to generate the forward embeddings;
reverse a time order of the merged online embeddings to obtain reversed online embeddings;
perform the offline refining on the reversed online embeddings to generate refined reversed online embeddings; and
reverse a time order of the refined reversed online embeddings to generate the backward embeddings.

23. The non-transitory computer-readable medium of claim 21, wherein the plurality of frames are divided into a plurality of clips, and
wherein to perform the refining, the instructions further cause the at least one processor to:
performing online refining on a group of query embeddings corresponding to each clip of the plurality of clips to generate forward online embeddings for each clip of the plurality of clips;
reverse a time order of the group of query embeddings to obtain a reversed group of query embeddings for each clip of the plurality of clips;
perform the online refining on the reversed group of query embeddings to generate refined reversed query embeddings for each clip of the plurality of clips;
reverse a time order of the refined reversed query embeddings to obtain backward online embeddings for each clip of the plurality of clips;
merge the forward online embeddings for the plurality of clips to obtain the forward embeddings; and
merge the backward online embeddings for the plurality of clips to obtain the backward embeddings.

24. (canceled)

25. The method of claim 21, wherein the features are extracted using an image encoder comprising a visual transformer model, and a visual transformer adapter configured to generate multiple-scale features based on an output of the visual transformer model.

26. (canceled)
